(19) United States
(12) Patent Application Publication
(10) Pub. No.: US 2017/0192154 A1
(43) Pub. Date: Jul. 6, 2017

(54) PLANT GROWTH LIGHTING SYSTEM

(71) Applicant: Argia Group LLC, Austin, TX (US)

(72) Inventors: Thomas Gilley, Austin, TX (US); Mark Walsh, Austin, TX (US)

(21) Appl. No.: 15/360,741

(22) Filed: Nov. 23, 2016

Related U.S. Application Data
(60) Provisional application No. 62/274,091, filed on Dec. 31, 2015.

(51) Int. Cl. F21V 8/00; A01G 7/04

(52) U.S. Cl. CPC G02B 6/0041; G02B 6/0031; G02B 6/0051; G02B 6/0083; G02B 6/0095; G02B 6/0085; A01G 7/045

(57) ABSTRACT

A system for plant growth lighting comprises a generally planar light guide sheet having an illumination surface, a back surface situated opposite the illumination surface, and at least one pair of opposingly disposed peripheral edge portions. The light guide sheet includes a plurality of structures to scatter and mix light received therein. Light is received within the light guide sheet as emitted from a series of Light Emitting Diode light sources (LEDs) selected to provide a photosynthetically active radiation (PAR) value. The series of LEDs may be located on the opposingly disposed peripheral edge portions, such that they direct light towards the other of the opposingly disposed peripheral edge portions. A reflective sheet is overlaid in optical communication with the back surface of the light guide. Light as received from the LEDs within the light guide is scattered and randomly mixed by the plurality of structures therein. A first amount of the scattered and randomly mixed light is directly propagated generally orthogonally through an illumination surface of the light guide, while another amount is reflected from the reflective sheet on the back surface of the light guide before being re-directed orthogonally through the illumination surface.

### RELATED APPLICATION

This application claims priority to U.S. Provisional Patent Application No. 62/274,091, entitled “Plant Growth Lighting System” filed Dec. 31, 2015, which is hereby incorporated by reference in its entirety.

### BACKGROUND

It has become increasingly feasible for light-emitting diodes (LED) to be used as lighting or irradiation sources to encourage plant growth. It is now possible using LED lighting sources for artificial and supplemental lighting, such as in artificial plant growth industrial complexes, to achieve a rate of plant growth that exceeds growth under natural sunlight conditions. LED lights are increasingly used for growing indoor crops as they provide a bright, cost-effective and long lasting light that can provide varying wavelengths of light that are essential to, and absorbed during, the photosynthetic process essential to plant growth. Recently, much emphasis has been placed on increasing the brightness of light emitting diodes (LEDs) for use as plant growth irradiation sources, among other uses. LEDs have become sufficiently inexpensive and bright in intensity for deployment as irradiation sources in a greenhouse environment, additionally providing a feature of light with adjustable color. Additionally, as LED sources consume a relatively small amount of power, using an LED-based illumination system minimizes the amount of collaterally-generated heat, a result that is desirable in a greenhouse environment where temperature control is important.

### BRIEF DESCRIPTION OF THE DRAWINGS

FIG. 1 illustrates an example arrangement of components of a plant growth lighting system.

FIG. 2 illustrates an example, in further detail, of components included in the plant growth lighting system.

FIG. 3 illustrates an example in deployment of the plant growth lighting system.

### DETAILED DESCRIPTION

Examples include a system for plant growth lighting by way of providing suitable photosynthetically active radiation (PAR) values to targeted plants or plant surfaces. Among other benefits, light received from Light Emitting Diode sources (LEDs) is randomly scattered and mixed in a relatively thorough manner by applying a plurality of light scattering structures provided within a secondary optics arrangement, such as, but not limited to, an “optical sandwich” arrangement and a light guide. A first amount of the randomly scattered and mixed light is directly propagated generally orthogonally through an illumination surface of the light guide, while another amount is reflected from a reflective sheet on a back surface of the light guide before being re-directed in the direction through, and generally orthogonal to, the illumination surface, thereby providing a relatively uniform distribution of photosynthetically active irradiation onto targeted plants or plant surfaces in accordance with the spectral emission characteristics of the LEDs.

A system for plant growth lighting comprises a generally planar light guide sheet having an illumination surface, a back surface situated opposite the illumination surface, and at least one pair of opposingly disposed peripheral edge portions. The light guide sheet includes a plurality of structures to scatter light received therein. Light is received within the light guide sheet as emitted from a series of Light Emitting Diode light sources (LEDs) selected to provide a photosynthetically active radiation (PAR) value. The series of LEDs may be located on ones of the opposingly disposed peripheral edge portions, such that they direct light towards the other of the opposingly disposed peripheral edge portions along a perimeter of the light guide. A reflective sheet is overlaid in optical communication with the back surface of the light guide. Light as received from the LEDs within the light guide is randomly scattered and mixed by the plurality of structures. A first portion of the randomly scattered and mixed light within the light guide is propagated directly through the illumination surface while a second portion is reflected by reflective sheet on the back surface of the light guide, and thereby re-directed generally orthogonally through the illumination surface in a relatively uniformly mix of light for distribution upon the targeted plants and plant surfaces.

The series of LEDs may include a first subset of LEDs selected to provide a first PAR value and at least a second subset of LEDs selected to provide a second PAR value in accordance with respective spectral emission characteristics of a color of the LEDs.

In some examples, the first subset of LEDs is selected to provide a target or desired PAR value via white light LEDs. A specific PAR value may be achieved using a combination of white LEDs such as cool white and warm white based on a range of correlated color temperature (CCT) values related to the color of light emitted from the white LED source. For instance, LED sources having relatively low CCT values ranging from 2,700 to 3,000 provide light that appears “warm”, while LED sources having high CCT values ranging from 4,000 to 6,500 provide light that appears “cool”. Warm white LEDs tend to have a predominant amount of red light in terms of spectral emission, whereas cool white LEDs tend to have a predominant amount of blue light in their spectrum. Thus, particular combinations of cool white and warm white LEDs can be selected and configured to achieve a desired or target PAR value to cater for irradiation and spectral absorption needs of a given plant species under cultivation, for example.

In other examples, the second subset of LEDs is selected to provide either a blue color and a red color to achieve a target PAR value as accentuated by the spectral emission characteristics of the respective LED color. Such a second subset may be applied in combination with the warm white and cool white LEDs to achieve a desired PAR value, or desired PAR values within a cycle for a given growth process for a given plant type.

The first subset of LEDs selected to provide the first PAR value and the second subset of LEDs selected to provide the second PAR value may be independently controlled and independently operable.

The LEDs may be mounted on a printed circuit substrate disposed along respective ones of the at least a pair of opposingly disposed peripheral edge portions of the light guide, with the printed circuit substrate being generally centered within a respective peripheral edge portion.

The LEDs may be provided in either a uniform or a non-uniform density in placement, or regularity, within the printed circuit substrate. The printed circuit substrates may be secured along the respective ones of the peripheral edge portions of the light guide at least partially by using a thermal adhesive or a mechanical fastener assembly.

In some examples, the printed circuit substrates, the planar light guide sheet and the reflective sheet are held together with a metal frame, the metal frame being in conductive thermal communication with the LEDs and the printed circuit substrates, thereby providing a heat sink for dissipation of heat generated during operation of the plant growth system. The metal frame is made of aluminum, in one example.

In other variations, a back plate is secured onto the metal frame, disposed towards a non-reflective or back surface of the reflective sheet. An electrical power supply may be remotely mounted and electrically interconnected with the series of LEDs.

The planar light guide sheet may be provided in a geometrical shape such as a rectangle, a square, an oval, a polygon, a circle, or a combination shape thereof.

In some examples, a diffuser sheet may be optionally provided in optical communication with, and underlying, the illumination surface of the light guide. The diffuser sheet may be made of an opaque polycarbonate material in one example, though other suitable opaque materials may be used.

The reflective sheet is made of a polyester material in one example, though other suitably reflective materials or surfaces may be used.

The generally planar light guide may be made of a light-propagating poly methyl methacrylate (PMMA) material in one variation, though other suitable light-propagating materials may be used. A plurality of structures provided within the light guide may be formed by scribed lines, screen printed features and molded-in features to scatter and randomly mix light being propagated within the light guide.

In another variation, a plant growth lighting assembly kit is provided, including at least some components of the plant growth lighting system. The plant growth lighting assembly may be implemented in panel lighting, flood lighting or spot lighting configurations, for example.

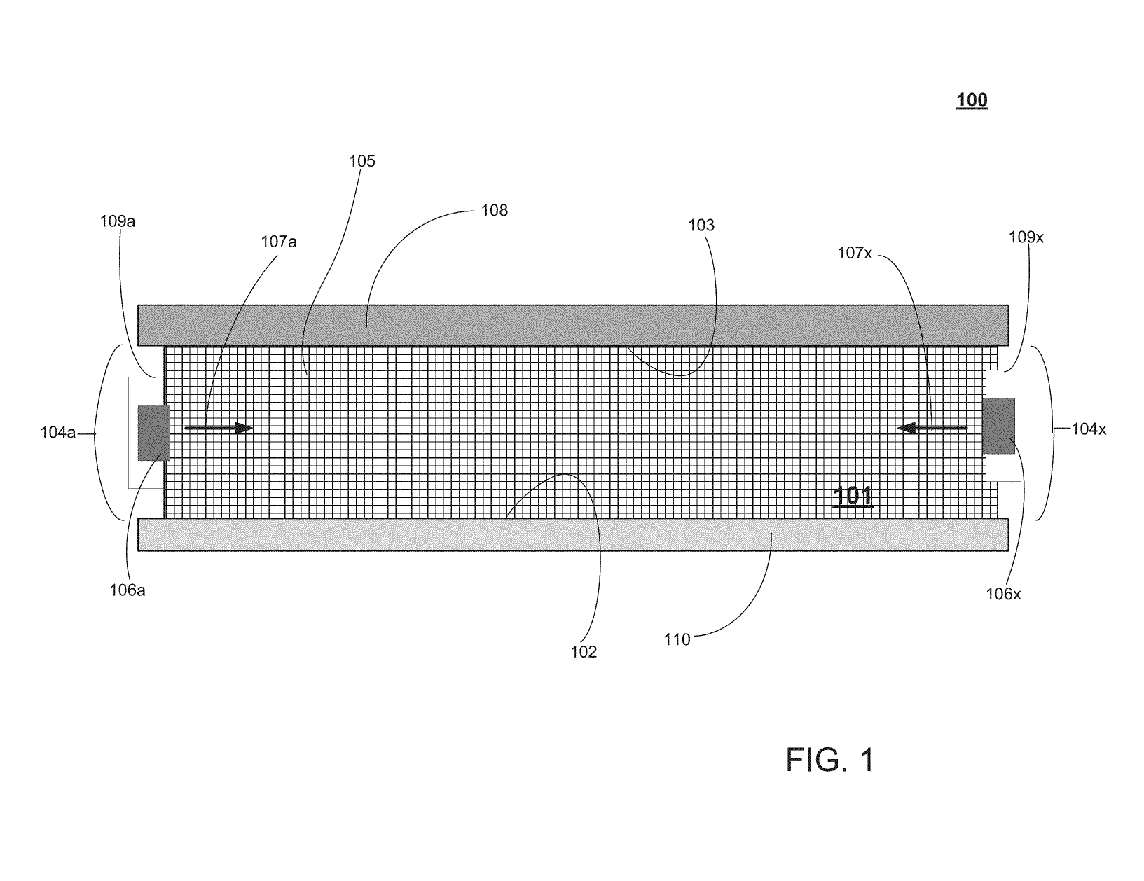

FIG. 1 illustrates plant growth lighting system 100, in an example cross sectional end view. Generally planar light guide sheet 101 (also referred to herein as light guide 101 and light guide sheet 101) has illumination surface 102, back surface 103 situated opposite peripheral edge portions 104a, 104x along a perimeter of light guide 101. Light guide sheet 101 includes a plurality of structures 105 to scatter light being transmitted or propagated therewithin. The term “generally planar” is meant to encompass surfaces of materials and objects that are constructed to be flat within variations permitted by manufacturing tolerances.

A series of Light Emitting Diode light sources (LEDs) 106a, 106x may be selected to provide a target, or a desired, photosynthetically active radiation (PAR) value in accordance with spectral emission characteristics of the LEDs. In particular, photosynthetically active radiation suitable for plant metabolism is radiation emitted in a spectral range typically from 400 nanometers to 700 nanometers. A series of LEDs including LEDs 106a, 106x may be located within respective printed circuit substrates 109a, 109x secured onto respective ones of a pair of opposingly disposed peripheral edge portions 104a, 104x, such that the series of LEDs 106a, 106x are oriented to direct light 107a, 107x towards each other located on the opposingly disposed peripheral edge portion.

Reflective sheet 108 is overlaid in optical communication with back surface 103 of generally planar light guide 101 to reflect scattered and mixed light or irradiation from light guide 101 that impinges upon reflective sheet 108. By way of this example arrangement of system 100, light or irradiation as received from LEDs 106a, 106x within light guide 101 is randomly scattered and mixed by plurality of structures 105. A first amount of the scattered and randomly mixed light is directly propagated generally orthogonally through illumination surface 102 of light guide 101, while another amount, impinging upon reflective sheet 103, is reflected therefrom and re-directed generally orthogonally through illumination surface 102 of light guide 101.

Generally planar light guide 101 may be made of a light-propagating poly methyl methacrylate (PMMA) material, though other materials having suitable or similar optical transmission properties may be used also.

Plurality of structures 105 included in light guide 101 may consist of any one type, or a combination of types, such as scribed lines, screen printed features and molded-in features to accomplish random scattering and mixing of light originating from LEDs 106a, 106x that is being propagated within light guide 101. Different degrees of light scattering and mixing thoroughness within light guide 101 may be achieved by varying factors such as the density and regularity in arrangement of the structures, and selection of particular structure types, formed integrally or otherwise and interposed within light guide 101.

According to a top view (not shown), generally planar light guide sheet 101 may be provided in varying geometrical shapes such as a rectangle, a square, an oval, a polygon, a circle, or any combination shape formed by combining selected features of those particular shapes.

Diffuser sheet 110 may be optionally provided, in some examples, in optical communication with, and underlying, illumination surface 102 of light guide 101, to accomplish a more even distribution of photosynthetically active irradiation emanating through illumination surface 102 onto growing plants or plant surfaces. In some examples, the diffuser sheet may be made of an opaque polycarbonate material, though other suitably opaque materials may be used.

In this manner, light or irradiation as received from the LEDs 106a, 106x within light guide 101 is randomly scattered and mixed by plurality of structures 105, then propagated into a direction through, and generally orthogonal to, illumination surface 102 of light guide 101.

In one example, reflective sheet 108 is made of a polyester material, though other materials providing suitably light-reflective surfaces may be used as well.

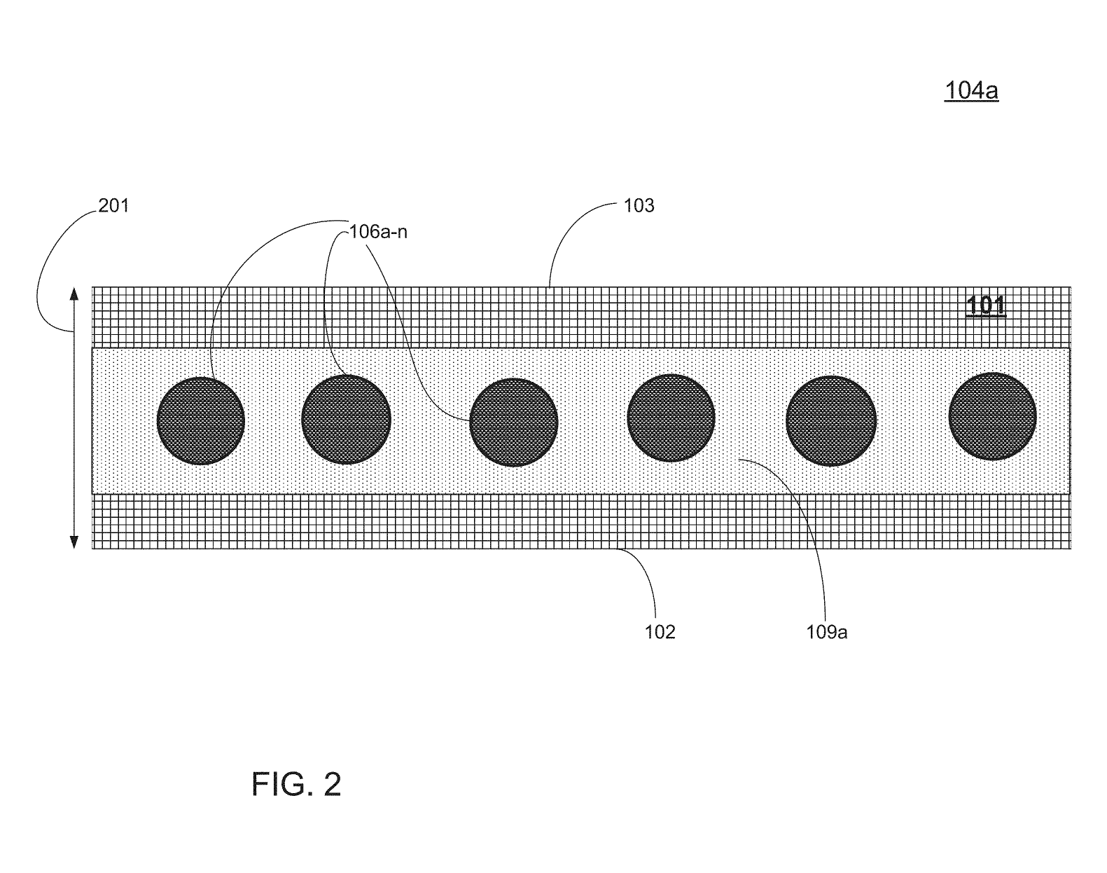

FIG. 2 illustrates an example in further detail of components deployed with light guide 101 of plant growth lighting system 100 in accordance with a side view of peripheral edge portion 104a.

In accordance with the side view illustrated by the example of FIG. 2, series of LEDs 106a-n (where n represents any positive integer number greater than 1) is mounted on printed circuit substrate 109a disposed along peripheral edge portions 104a of light guide 101. Printed circuit substrate 109a may be thinner than and generally centered within thickness dimension 201 of peripheral edge portion 104a of light guide 101. The printed circuit substrate may be such as a metal core printed circuit board, an FR4 printed circuit board or similar construction.

The series of LEDs 106a-n may include one or more subsets of LEDs selected to provide respective or different PAR values. The PAR values may be selected in accordance with irradiation and spectral absorption needs of the particular plant species being grown or the stage of plant growth or development being addressed or targeted.

In some examples, different subsets of LEDs may be provided within the series of LEDs 106a-n, 106x-n located along respective peripheral edge portions 104a, 104x to provide a desired PAR value via white light LEDs, red LEDs, and blue LEDs, in various combinations thereof to achieve the target PAR value in accordance with the spectral emission characteristics of the particular LEDs.

In variations, the first subset of LEDs is selected to achieve a PAR value using a combination of white LEDs such as cool white and warm white. The terms cool white and warm white may be specified according to a range of correlated color temperature (CCT) values related to the color of light emitted from the white light LED source. For instance, white light LED sources having (relatively) low CCT values ranging from 2,700 to 3,000 provide light that appears “warm”, while white light LED sources having high CCT values ranging from 4,000 to 6,500 provide light that appears “cool”. Warm white LEDs tend to have a predominant amount of red light in terms of spectral emission and attendant emissive wavelength. Cool white LEDs, in contrast, tend to have a predominant amount of blue light in their spectrum, and are therefore capable of providing a higher amount or a higher concentration of the blue light emissive wavelength associated therewith. Thus, particular combinations of cool white and warm white LEDs can be tailored and applied to achieve a desired or target PAR value or spectral emission characteristics to cater for irradiation absorption needs of a given plant species under cultivation, for example. In variations, the above described technique of using combinations of white LEDs having different CCT values, and also red and blue LEDs, may be implemented not only in panel lighting configurations, but also in flood lighting and spot lighting configurations using LEDs. For instance, blue color LEDs typically have an emissive wavelength ranging from 400 nm to 480 nm, while emissive wavelength of red color LEDs typically range from 650 nm to 700 nm.

In further examples, the different subsets of LEDs, or even individual LEDs within a given subset, located along respective peripheral edge portions 104a, 104x may be independently controlled for independent operation via suitable programmable controls in electrical operation. For example, On/Off states and brightness intensity levels of individual LEDs, or subsets of LEDs of a given color and emission characteristics, may be adjusted in accordance with predetermined or programmable settings.

In some examples, the series of LEDs 106a-n, 106x-n located along respective peripheral edge portions 104a, 104x may be located in a uniform or a non-uniform density in placement, or regularity in placement, of the LEDs within printed circuit substrate 109a, 109x.

Printed circuit substrates, including but not limited to rigid, semi-rigid and flexible printed circuit boards may be secured along respective peripheral edge portions 104a, 104x at least partially using a thermal adhesive, a mechanical fastener or other fastening assembly.

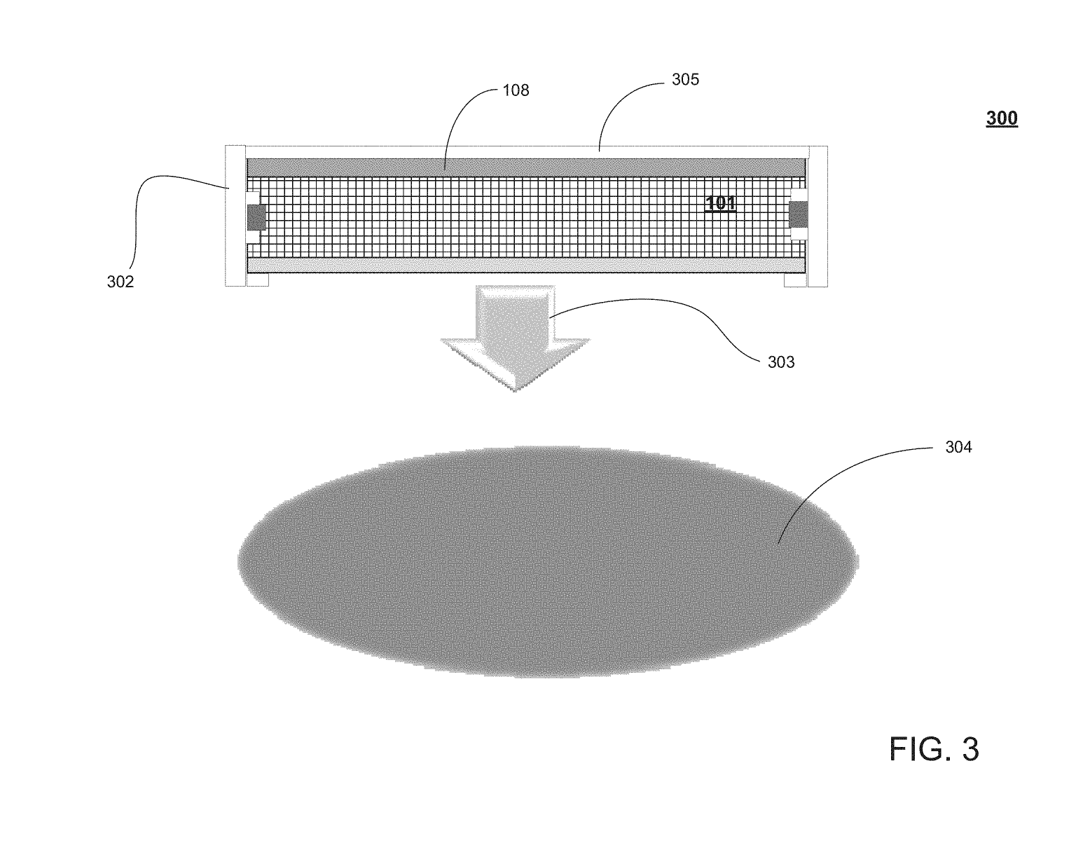

FIG. 3 illustrates an example deployment of plant growth lighting system 300, including components as described in regard to FIGS. 1 and 2. Light or irradiation received from Light Emitting Diode sources (LEDs) 106a-n, 106x-n is randomly scattered by plurality of structures 105 within light guide 101 and thereby thoroughly mixed or blended, in particular when the light received from LEDs 106a-n, 106x-n include light having different colors, or white light having different CCT values or otherwise varying irradiation characteristics. A first amount of the randomly scattered and blended light is propagated directly and generally orthogonally through illumination surface 102 of light guide 101, while another amount, impinging upon reflective sheet 108 on back surface 103 of light guide 101, is reflected from reflective sheet 108 into direction 303 through, and generally orthogonal to, illumination surface 102, thereby providing a relatively uniform distribution of photosynthetically active irradiation 304 onto targeted plants or plant surfaces in accordance with the spectral emission characteristics particular to the LEDs. It will be further appreciated that direction 303 of the emitted mixed light intended for distribution onto plant surfaces is also orthogonal, or 90 degrees different in direction, from the original source light of the series of LEDs 106a, 106x directing light according to directions 107a, 107x with regard to the opposingly disposed peripheral edge portions of light guide 101. In this manner, light emanating or received from LEDs 106a, 106x is not directly directed onto plant surfaces, but rather, undergoes a thorough mixing before being distributed in a accordance with a uniform blend onto target plant surfaces or plants.

In some examples, printed circuit substrates 109a, 109x, which may include (but not limited to) rigid, semi-rigid and flexible printed circuit boards, generally planar light guide sheet 101 and reflective sheet 108 are held together in fixed arrangement within 302 metal frame, the metal frame being in conductive thermal communication with the LEDs and the printed circuit substrates, thereby providing a heat sink therefor, to prevent any adverse accumulation of heat generated in operation of plant growth lighting system 300. In one example, metal frame 302 may be made of aluminum, though other thermally conductive, suitably rigid materials may be used. Suitable mechanical fasteners including brackets and clamps may be used as necessary in building and securing the metal frame.

In another variation, back plate 305 may be secured onto metal frame 302, and disposed towards a back or non-reflective surface of reflective sheet 108. An electrical power supply for operation of the electrical components of plant growth system 300, including the series of LEDs 106a-n, 106x-n may be provided as part of the plant growth lighting system or the lighting system assembly, mounted either integrally upon back plate 305 or to be interconnected remotely therewith.

Although illustrative embodiments have been described in detail herein with reference to the accompanying drawings, variations to specific embodiments and details are encompassed by this disclosure. It is intended that the scope of embodiments described herein be defined by the claims and their equivalents. Furthermore, it is contemplated that a particular feature described, either individually or as part of an embodiment, can be combined with other individually described features, or parts of other embodiments. Thus, the absence of describing specific combinations should not preclude the inventor(s) from claiming rights to such combinations.

What is claimed is:

1. A system for plant growth lighting comprising:
a generally planar light guide sheet having an illumination surface, a back surface situated opposite the illumination surface, and at least a pair of opposingly disposed peripheral edge portions, the light guide sheet including a plurality of structures to scatter light received therein;
a series of Light Emitting Diode light sources (LEDs) selected to provide a photosynthetically active radiation (PAR) value, the series of LEDs located on ones of the at least a pair of the opposingly disposed peripheral edge portions, ones of the series of LEDs being oriented to direct light towards another of the at least a pair of the opposingly disposed peripheral edge portions; and
a reflective sheet overlaid in optical communication with the back surface of the generally planar light guide;
wherein light as received from the LEDs within the light guide is scattered and mixed by the plurality of structures, and orthogonally re-directed into a direction through the illumination surface.

2. The system of claim 1 wherein the PAR value is a first PAR value, and the series of LEDs includes a first subset of LEDs selected to provide the first PAR value, and further includes at least a second subset of LEDs selected to provide at least a second PAR value.

3. The system of claim 2 wherein the first subset of LEDs is selected to provide a PAR value via white light LEDs, the white light LEDS including at least one of an arrangement of cool white LEDs and warm white LEDs in accordance with a range of correlated color temperature (CCT) values.

4. The system of claim 2 wherein the at least a second subset of LEDs is selected to provide one of a blue color having an emissive wavelength ranging from 400 nm to 480 nm and a red color having an emissive wavelength ranging from 650 nm to 700 nm.to achieve a target PAR value.

5. The system of claim 2 wherein the first subset of LEDs selected to provide the first PAR value and the at least a second subset of LEDs selected to provide the at least a second PAR value are independently controlled and independently operable.

6. The system of claim 1 wherein the series of LEDs is mounted on a printed circuit substrate disposed along respective ones of the at least a pair of opposingly disposed peripheral edge portions, the printed circuit substrate being generally centered within the respective ones of the peripheral edge portions.

7. The system of claim 6 wherein the series of LEDs consist of: one of a uniform and a non-uniform density in placement of the LEDs within the printed circuit substrate.

8. The system of claim 6 wherein the printed circuit substrates are secured along the respective ones of the at least a pair of opposingly disposed peripheral edge portions at least partially by one of a thermal adhesive and a mechanical assembly.

9. The system of claim 6 wherein the printed circuit substrates, the generally planar light guide sheet and the reflective sheet are held together with a metal frame, the metal frame being in conductive thermal communication with the LEDs and the printed circuit substrates.

10. The system of claim 9 wherein the metal frame consists of aluminum.

11. The system of claim 9 further comprising:
a back plate secured onto the metal frame and disposed towards a non-reflective surface of the reflective sheet; and
an electrical power supply remotely mounted in electrical communication with the series of LEDs.

12. The system of claim 1 wherein the generally planar light guide sheet is provided in a geometrical shape consisting of one of: a rectangle, a square, an oval, a polygon, a circle and a combination shape thereof.

13. The system of claim 1 further comprising:
a diffuser sheet provided in optical communication with, and underlying, the illumination surface of the generally planar light guide.

14. The system of claim 13 wherein the diffuser sheet comprises an opaque polycarbonate material.

15. The system of claim 1 wherein the reflective sheet comprises a polyester material.

16. The system of claim 1 wherein the generally planar light guide comprises a light-propagating poly methyl methacrylate (PMMA) material.

17. The system of claim 1 wherein the plurality of structures of the light guide consists of a structure type of one of: scribed lines, screen printed features and molded-in features.

18. A plant growth lighting assembly comprising:
a generally planar light guide sheet having an illumination surface, a back surface situated opposite the illumination surface, and at least a pair of opposingly disposed peripheral edge portions, the light guide sheet including a plurality of structures to scatter light received therein;
a series of Light Emitting Diode light sources (LEDs) selected to provide a photosynthetically active radiation (PAR) value, the series of LEDs located on ones of the at least a pair of the opposingly disposed peripheral edge portions, ones of the series of LEDs being oriented to direct light towards another of the at least a pair of the opposingly disposed peripheral edge portions; and
a reflective sheet overlaid in optical communication with the back surface of the generally planar light guide;
wherein light as received from the LEDs within the light guide is scattered and mixed by the plurality of structures, and orthogonally re-directed for emission through the illumination surface.

19. The lighting assembly of claim 18 wherein the lighting assembly is implemented in accordance with a flood lighting configuration.

20. The lighting assembly of claim 18 wherein the lighting assembly is implemented in accordance with a spot lighting configuration.
